(19) United States
(12) Patent Application Publication
(10) Pub. No.: US 2025/0060993 A1
(43) Pub. Date: Feb. 20, 2025

(54) SYSTEMS AND METHODS FOR EFFICIENT MOVEMENT OF VARIED DATASETS

(71) Applicant: JPMORGAN CHASE BANK, N.A., New York, NY (US)

(72) Inventors: Sarita BAKST, Brooklyn, NY (US); Srikrishna KULKARNI, Hyderabad (IN); Tasleem BANU, Hyderabad (IN); KrishnaPrashanth DHARANIKOTA, Hyderabad (IN); Aditya GAMPA, Hyderabad (IN); Sayani DUTTA, Kolkata (IN); Rahul KUMAR, Gaya (IN); Ajay BONDU, Hyderabad (IN); Chandrasekhar MUVVA, Hyderabad (IN)

(21) Appl. No.: 18/807,665

(22) Filed: Aug. 16, 2024

(30) Foreign Application Priority Data
Aug. 17, 2023 (IN) 202311055224

(51) Int. Cl. G06F 9/48; G06F 9/50

(52) U.S. Cl. CPC G06F 9/4881; G06F 9/5038

(57) ABSTRACT

The techniques described herein relate to a method including: providing a data movement agent; providing a data movement control plane; determining, by the data movement agent, a work order, wherein the work order indicates a dataset to be moved; including, in the work order, a concurrency configuration, wherein the concurrency configuration indicates a number of parts that a file included in the dataset will be partitioned into, and a number of threads from an available thread pool that will be used to execute movement of the number of parts to a destination; receiving, by the data movement control plane and from the data movement agent, the work order; and executing, by the data movement control plane, the work order.

### RELATED APPLICATIONS

This application claims the benefit of Indian Provisional Patent Application Ser. No. 202311055224, filed Aug. 17, 2023. The disclosure of this application is hereby incorporated, by reference, in its entirety.

### BACKGROUND

### 1. Field of the Invention

This disclosure generally relates to efficient movement of varied datasets supporting heterogeneous data sources and destinations.

### 2. Description of the Related Art

As more enterprise organizations begin to use cloud or hybrid cloud/on-premises data storage and processing, efficient movement of varied files and datasets to cloud storage as a primary or synchronized storage location has become an important exercise. Traditionally, movement of data has been a challenge due to the variety of sources and destinations. Each source and destination require a unique authentication and/or authorization for a user/client. Designing a product to address these use requirements and moving data at high transfer rates along with telemetry and registration of metadata without comprising data quality is a complex task.

Conventionally, datasets on premises individual computers, servers, and internal networks were difficult to manage, being dispersed, and further to move to a public cloud. Enormous resources are required to move, format, and sync these different datasets. Disclosed systems and methods mitigate or eliminate these issues by providing efficient and convenient systems and methods for batch operations and bulk migrations, as well as for small datasets in disparate systems. Further, disclosed systems and methods can unlock key services on the public cloud and ensure controls are in place to protect and manage the datasets.

Additionally, data storage demand continues to grow for individuals and companies. Data storage on individual units or servers can be problematic because it cannot be integrated with larger stores of knowledge on other systems. While public clouds exist for data storage, a need exists to move large amounts of data from individual units or servers to the public cloud. Improved systems will allow efficient and effective movement of data to the public cloud while allowing for key services and data protection.

As such, there is a need for a process where the source and destination are agnostic and can run on a variety of different connectors, with custom transformations, conversions, encryption, filters, field enrichment, telemetry tags, and supports bulk, large file movements. Further, there is a need for rapidly moving bulk files or folders.

### SUMMARY

Systems and methods for efficient movement of varied datasets are disclosed. In some embodiments, the techniques described herein relate to a method including: providing a data movement control plane; determining, by the data movement agent, a work order, wherein the work order indicates a dataset to be moved; including, in the work order, a concurrency configuration, wherein the concurrency configuration indicates a number of parts that a file included in the dataset will be partitioned into, and a number of threads from an available thread pool that will be used to execute movement of the number of parts to a destination; receiving, by the data movement control plane and from the data movement agent, the work order; and executing, by the data movement control plane, the work order.

According to some embodiments, systems and methods for managing and moving datasets can comprise receiving a work order for a data transfer at a control plane from an agent; generating, by the control plane, an order table including the work order, a tenancy associated with the agent, and a unique identifier associated with the agent; determining a leader for the work order based on a priority of which leaders are available, a type of port, a type of role associated with the agent, and the unique identifier, wherein the leader is appointed to a logical group of agents and the leader controls an order of the order table; generating a preflight request to identify an entitlement agent based on a capability of the entitlement agent, the capability comprising a number of available threads; and based on an approval of the preflight request, generating execution request files for a queue table for execution of the data transfer.

In some embodiments, the unique identifier is generated for the agent based on the internet protocol (IP) address of the agent. In some embodiments, the capability of the entitlement agent is based on an adjacency identified in a graph-based mapping of services. In some embodiments, the capability of the entitlement agent is based on matching the capability of the entitlement agent with a data upload capability of the agent. In some embodiments, the data upload capability of the agent comprising one or more of a multi-part size of the file and a concurrency. In some embodiments, the method further comprises updating an execution table with a logical identifier indicating a state of the data transfer. In some embodiments, the method further comprises upon the state reflecting that the execution request did not occur, allocating a new leader to complete the data transfer.

In some embodiments, the techniques described herein relate to systems and methods including one or more processors that execute instructions, for example stored on a memory.

### BRIEF DESCRIPTION OF THE DRAWINGS

FIG. 1 illustrates a system diagram of a data management on-premises architecture, in accordance with embodiments;

FIG. 2 illustrates a system diagram of a data management on-premises architecture, in accordance with embodiments;

FIG. 3 illustrates a process diagram of an agent registration process, in accordance with embodiments;

FIG. 4 illustrates a process diagram of an agent mapping process, in accordance with embodiments;

FIG. 5 illustrates a process diagram of a work order placement process, in accordance with embodiments;

FIG. 6 illustrates a process diagram of a dataset transfer determination process, in accordance with embodiments;

FIG. 7 illustrates a data transfer graphical architecture mapping, in accordance with embodiments;

FIG. 8 illustrates a process diagram of a dataset transfer management process, in accordance with embodiments; and

FIG. 9 illustrates a block diagram of a computing device for implementing certain embodiments of the present disclosure.

### DETAILED DESCRIPTION

In accordance with embodiments disclosed herein, systems and methods for efficient movement of varied datasets can support heterogeneous data sources and destinations. Disclosed embodiments support heterogeneous data sources and destinations with a common trusted authentication/authorization to facilitate multi tenancy through fine grain controls. Disclosed embodiments may include an artificial intelligence and/or a machine learning (ML) model to identify a type of data (irrespective of file formats, sizes, or volumes), and an availability of computing resources. Disclosed embodiments can provide efficient transfer rates relative to conventional data movement schemes, allowing implementing organizations to move data across the platforms (e.g., on-premises and/or cloud-based platforms) in a seamless and accelerated manner.

Disclosed embodiments may include an agent that executes on a local computing resource and that may be acquired by an end user. For instance, an agent may be downloaded from a universal resource locator (URL) and may be installed by an end user at a device or in a virtual operating system (OS) environment (e.g., where data resides). The agent installation package may include files such as a jar file (i.e., a compressed or “zipped” file) that contains other installation files. Other installation files may include a configuration file, a shell script file, a .bat (batch) script file, and/or installation executables. An installing user may update a configuration file with communication and/or location details such as a domain naming service (DNS) name or a URL location of the backend service including a service control plane, a type of agent (e.g., whether the agent is based on a software development kit (SDK) and integrated into another computer application, or whether the agent is a stream connector), and/or credentials for an application programming interface with a control plane. An agent installation script, when executed, may register the supplied settings with a control plane and may provide a user interface (e.g., a graphical user interface (GUI) with which an end use may interact.

For some embodiments, when an agent makes an in initial call to a control plane, several actions may occur. For instance, if the call is a first-time registration from an agent to a control plane, the control plane may allocate a universally unique identifier (UUID) based on an internet protocol (IP) address of or associated with the calling agent. A port (e.g., a firewall port) may then be assigned to the IP address. Once communication is established, an agent interface may be presented to a user via an interface of a device that the agent is executing on.

Benefits of the disclosed embodiments are that the source and destination are agnostic and can run on a variety of different connectors, with custom transformations, conversions, encryption, filters, field enrichment, telemetry tags, and supports bulk, large file movements. The platform can be an on premises platform or a cloud infrastructure. The disclosed systems and methods also enable secure transfers through multiple authentication and authorization. The disclosed systems and methods also enable rapidly moving bulk files or folders with throughputs up to 20 Terabytes per hour. The disclosed systems and methods further enable seamless integration with upstream and down stream systems. The disclosed systems and methods further support custom configurations and tags while data moves. The disclosed systems and methods are further resilient and have considerable fault tolerance.

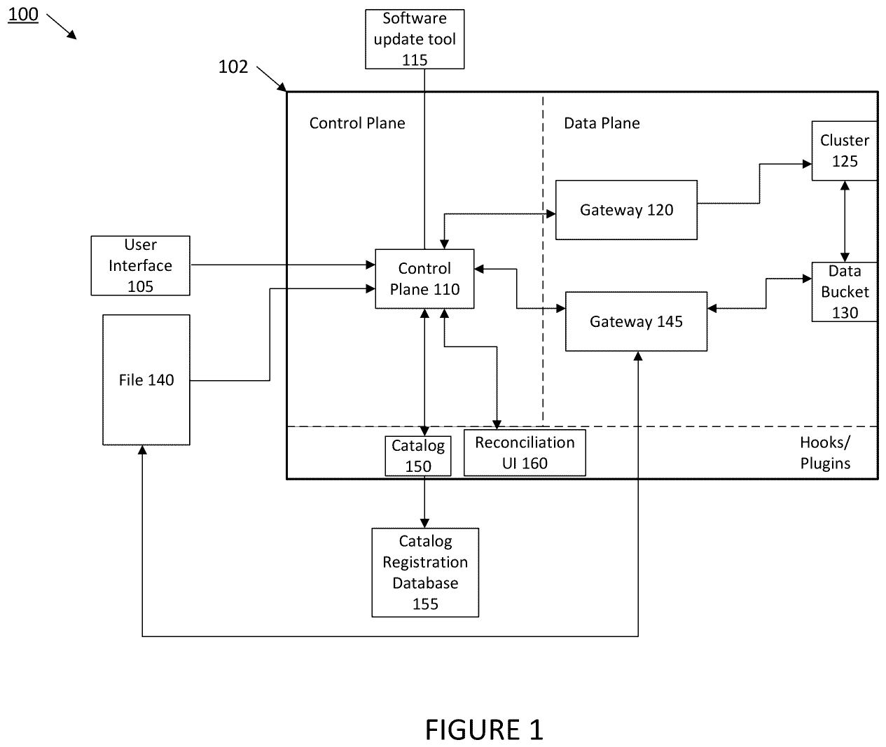

Referring to FIG. 1, a system diagram of a data management on-premises architecture 100 is illustrated according to some embodiments. Depending on the implementation, the data management on-premises architecture 100 can include software modules executed on one or more processors, where instructions for the software modules are stored on one or more databases of a computer network.

The data management on-premises architecture 100 may include a user interface 105. The user interface 105 may be used to receive a trigger for an ad-hoc/on-demand job or an order for a scheduled job. Application programming interfaces (APIs) and/or a content and language integrated learning (CLIL) program can be configured to generate a trigger based on a user interaction with the user interface 105 and/or at a scheduled timeframe.

The trigger from the user interface 105 may be received at a control plane 110 as part of a computer system 102. The control plane 110 can be executed on a Groups, Algorithms, and Programs (GAP), a Graphics Kernal Processor (GKP), or a standalone computer-implemented software. The control plane 110 may be a software module operating on a control plane of a computer network and able to communicate with one or more gateways of a data plane. The control plane may include functions and processes that determine which path to use to send data. The data plane may include functions and processes that forward data between interfaces.

The control plane 110 may be inserted or updated though an executable, a reconfiguration, and/or a regulation status in connection to a software update tool 115. The software update tool 115 may be a Remote Desktop Services (RDS) or a Grade of Service (GOS).

The control plane 110 can communicate with an API call to trigger a copying tool through a gateway 120 in response to the trigger from user interface 105. The API call may include a trigger of a called distributed copy (DistCp) software module. The gateway 120 may be a virtual interface for a private network connection between different computers of a computer network. The gateway 120 may comprise a connector, such as a software framework for storing data and running one or more applications on one or more clusters of hardware, and a DistCp job call. In response to the API call, the gateway 120 may transfer a sync call to the control plane 110. The sync call may include an execution identification.

The gateway 120 can submit a job to a cluster of computers 125 for data processing. The gateway 120 may include a connector The cluster of computers 125 can be a Hadoop cluster, or a network of nodes that perform parallel data processing on data sets. The cluster of computers may return a job identification to the gateway 120. The gateway 120 can receive an update to a job status from the cluster of computers 125.

As a result of the submitted job, the cluster of computers 125 can send a dataset distributed copy to a data bucket 130. The data bucket 130 may be a public cloud storage resource. The data bucket 130 may be an online storage through a web service interface.

In some embodiments, a file 140 may trigger a data movement job. The file 140 may be stored on a database connected to control plane 110, such as an online repository or a local network. The trigger may cause a file 140 be uploaded through control plane 110. The trigger may be the file being stored on the database. The trigger may be a timed upload (e.g., to synchronize databases).

The control plane 110 may communicate with a gateway 145 with a sync call for a job in response to receiving the file and/or the trigger. The gateway 145 may comprise an on-premises bucket and/or a software development kit (SDK) connector. The gateway 145 may pull the file 140 from the database in response to the sync call. The gateway 145 may upload the file 140 to the data bucket 130 once it is pulled from the database. The gateway 145 may receive a return status based on the progress of the upload of file 140 to the data bucket 130. The upload may be part of a multipart upload.

After the gateway 145 receives the return status, an update status may be generated from the gateway 145 for the control plane 110. In response to the update status, the control plane 110 may use a call registration API to register the data transfer in a catalog 150. The catalog 150 may be on a hooks and/or plugins plane of the computer network. The catalog 150 may perform registration on a catalog registration database 155. The catalog registration database 155 may be external to the computer network.

After registration, the control plane 110 may use sync call to a reconciliation user interface 160 to update one or more reconciliation metrics on a user interface. In some embodiments, the one or more reconciliation metrics may include a completion percentage, a speed of upload, an indication of complete transfer, or similar.

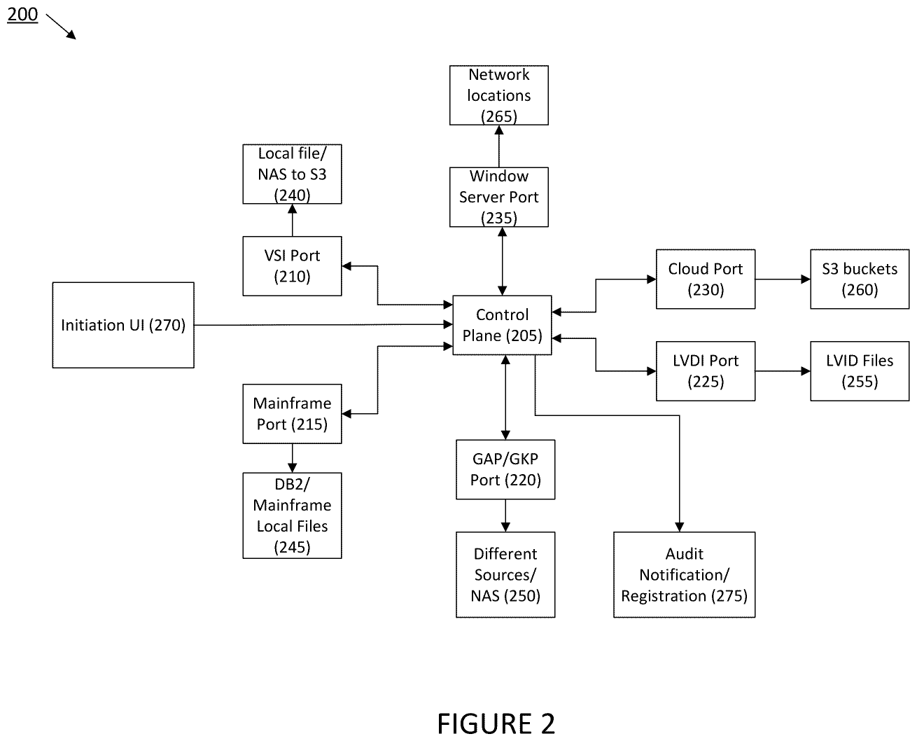

Referring to FIG. 2, a system diagram of a data management on-premises architecture 200 is illustrated according to some embodiments. Depending on the implementation, the data management cloud-based architecture 200 can include software modules executed on one or more processors of servers accessed through the internet, where instructions for the software modules are stored on databases of the servers.

A user may initiate a transfer through an initiation user interface 270. To access the initiation user interface 270, the user can download an agent from an online system. In some embodiments, the user may register the agent with a credential type. The agent may shake hands with a control for certificate and an appointed User Role. The user can provide a chosen file path and location and/or a default file path and location may be set. The agent may be in communication with a control plane 205 on a cloud or an on-premises computer.

The control plane 205 may connect a number of ports to different systems including one or more of a virtual service identifier (VSI) port 210, a mainframe port 215, a GAP/GKP port 220, a virtual desktop infrastructure (LVDI) port 225, a cloud port 230, or a window server port 235. In some embodiments, the ports may be agents of a database movement management system. The agents may be software modules executed by a computer or server associate with each of the ports.

The VSI port 210 may be used to read and/or write from local files or network-attached storage (NAS) 240. The VSI port 210 may be used to read and/or write to a data bucket (e.g., data bucket 130 of FIG. 1).

The mainframe port 215 may be used to read and/or write from a database or mainframe local files 245. The database may be a standard database (e.g., DB2).

The GAP/GKP port 220 may be used to read and/or write from different database sources and/or network-attached storage (NAS) 250.

The LVID port 225 may be used to read and/or write LVDI files 255.

The cloud port 230 may be used to read and/or write data bucket files to another, separate data bucket 260.

In some embodiments, the control plane 205 can notify or register entries (e.g., audit entries) in an audit database 275.

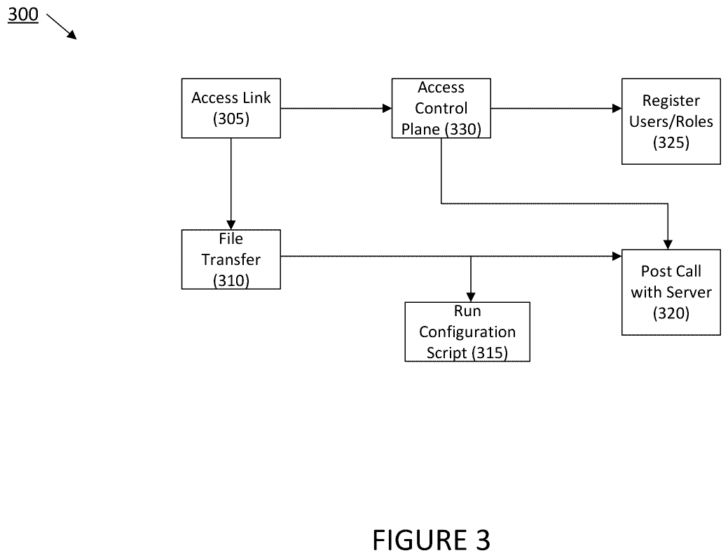

FIG. 3 illustrates a process diagram of an agent registration process 300 according to some embodiments. The process 300 may be in the form of instructions executed by one or more processors.

In step 305, a user can download or access a link through a user interface, for example, through an agent download uniform resource locator (URL).

In step 310, a file transfer may be executed to upload a file into a connected database.

In step 315, a configuration script may be run to prepare a connected server for the file transfer. For example, the connected server can be prepared to receive a call for a file transfer and/or receive confirmation of a validated role in order to initiate a file transfer. Once the script is run, it can auto-register with a logical name through the control plane and runs in the background.

In step 320, a control plane may post a call with a connected server with a validated role in order to execute the file transfer from the connected database to a destination database.

In step 330, the user may validate its role through a validation download link downloaded through the control plane.

In step 325, the user's role can be confirmed from a database of roles and/or an appointment of a role based on a credential of the user. The credential can be a unique identifier, an internet protocol (IP), an encrypted saved role access credential, a type of port used by the user, or a type of agent used by the user (e.g., stream or SDK based mode). Once the role is confirmed through the validation download link, the agent can run automatically on computing resources of the user (e.g., a local computer network, a cloud-based server).

Step 325 also may include generating a mapping table that indicates a relationship between a user's/agent's registration information (e.g., a credential of the user/agent) and any roles associated with the user/agent. Based on a priority of which leaders are available, best suited to the type of agent or port, the type of role, and/or a unique identifier, a leader may be selected for the logical group of an agent. Leader responsibilities may include order distribution, preflight request status, etc. Step 325 may include a tenancy level being allocated to the user based on an allocated UUID and/or a role.

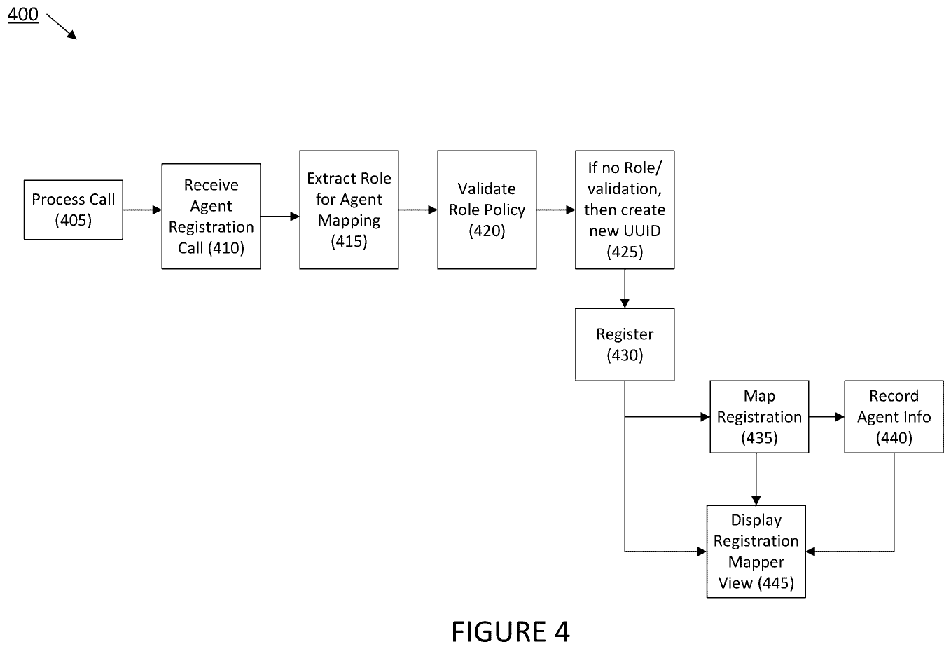

FIG. 4 illustrates a process diagram of an agent mapping process 400 according to some embodiments. Depending on the implementation, the process 400 may be in the form of instructions executed by a processor.

In step 405, a user may place a work order using an interface of an agent. For example, the work order may be communicated to a control plane that the agent is in operative communication with. In some embodiments, the order may take the form of an API method call to an API method that is provided to a control plane. An API method called by an agent may include parameterized data as parameters or arguments of the method.

In step 410, the call may be received by the control plane. In the case of an API, parameters may be extracted from the call for further processing. The control plane may be in communication with a user interface though a status update through one or more APIs.

In step 415, a role will be extracted from the process call. The role may be confirmed by use of an active directory federation services (ADFS) token within the process call.

In step 420, a role policy validator may determine whether to allow the call to be answered and data to be transferred based on the extracted role. The role policy validator may apply rules for multi-tenancy mapping such as an amount of data, a location of the data, a role of the agent, etc.

In step 425, if the role is not validated or if a role does not exist, then it can be determined to create a new UUID and an associated role. For example, if no role is available for an agent's IP, then a new UUID may be created. In some embodiments, the user may be able to edit the UUID or a logical name in a user interface. In some embodiments, if the agent's IP has more than one role, then a hash mapper can be created to create the UUID with association to more than one role (e.g., merging different UUIDs into one string).

In step 430, the new role may be registered. The new role may be associated with a UUID, a logical name, and/or a tenancy identifier. The UUID If may be allocated based on an IP address associated with the user. If any of the UUID, logical name, and/or tenancy identifier already exists, then the missing information may be allocated to the role.

In step 435, the registration of the new role may be mapped. The mapping may include a registration identifier, an agent identifier, and determining a leader and/or priority. Based on the roles of the UUID, mapper table is created between the agent and UUID.

In step 440, the agent information may be recorded. The recording may include an IP address, a port number, and a type of operating system associated with a server or the computing network.

In step 445, the registration mapping from step 435 may be displayed.

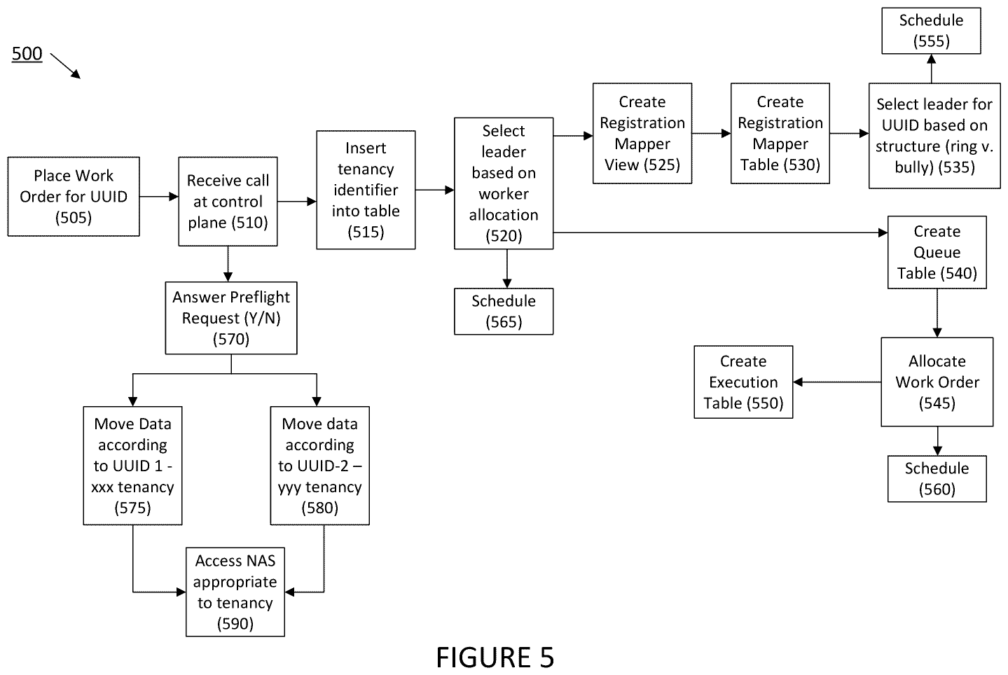

FIG. 5 illustrates a work order placement process 500 according to some embodiments. Depending on the implementation, the process 500 may be in the form of instructions executed by a processor.

In step 505, a work order may be placed, for example at a user interface. The work order may be associated with a UUID.

In step 510, the work order may be received at a control plane.

In step 515, a tenancy identifier may be inserted into a work order table with the work order and the UUID. The order table may include the UUID and tenancy information of the calling agent.

In step 520, the leader for the work order will be selected based on worker allocation, the UUID, priority, leader availability, and one or more roles associated with the UUID.

In step 565, a scheduler may schedule the work order in a queue table (see step 540) based on the leader selection. The scheduler that executes at the control plane may continuously poll and update a leader for the UUID and tenancy in the registration mapper table. The scheduler may poll the order table (see step 515) and may generate a pre-work order request to identify the entitlement agent for the work order in order to ensure maximum throughput.

In step 525, a registration mapper view may be created to map roles associated with the UUID.

In step 530, a registration mapper table may be created to record roles associated with the UUID.

In step 535, the leader for the UUID for future work orders may be selected based on a configuration of the structure used for data storage. For example, the configuration may be a ring structure or a bully structure.

In step 555, similar to step 565, the scheduler may schedule the work order in the queue table based on the leader selection and continuously poll and update a leader for the UUID and tenancy in the registration mapper table. The scheduler may poll the order table (see step 515) and may generate a pre-work order request to identify the entitlement agent for the work order in order to ensure maximum throughput.

In step 540, a queue table may be created with one or more work orders for the leader according to priority. The one or more work orders can originate with any number of UUIDs of any number of users.

In step 545, a work order may be allocated as a result of reaching the end of the queue table.

In step 550, an execution table may be created with a executed work orders. Updating user interfaces and job completion/incompletion reports and notifications may occur as a result of the executed work order being recorded in the execution table.

In step 560, similar to step 565, the scheduler may schedule the work order in the queue table based on the leader selection. In some embodiments, the scheduler may continuously poll and update a leader for the UUID and tenancy in the registration mapper table. The scheduler may poll the order table (see step 515) and may generate a pre-work order request to identify the entitlement agent for the work order to ensure maximum throughput. Once the pre-work order is completed, then an actual execution request may be placed in the queue table (see step 540) for the agent with respect to data movement indicated in the work order. The scheduler may update the order table as work orders are processed. If a requesting agent fails, then a leader agent may take control of the work order creation and execution process.

In step 570, a determination can be made of whether data is ready to be moved. The result of the determination can be yes or no.

In steps 575 and 580, based on the determination, the data can be moved according to an associated tenancy. For example, for UUID1, data can be moved to a xxx tenancy database while for UUID2, data can be moved to a yyy tenancy database.

In step 590, according to the data movement of steps 575, 580, the read and/or write functionality of network-attached storage (NAS) may be accessed.

In some embodiments, once a user places, or a system determines, the order via API/UI for the UUID then following sequence of action happens: The control plane places the order into order table with UUID with tenancy information; a scheduler will keep polling and update the leader for the UUID and tenancy in the agent mapper table; a scheduler will poll the order table and place the request in the preflight request to identify the entitlement agent for that request for maximize the throughput; once the preflight is complete then actual execution request files will be placed in the staging area for the entitled the agent for the movement; once the request is complete for single then execution table with logical ID will be updated; and, if any agent fails, then work order creation will be performed by the control plane and a leader agent.

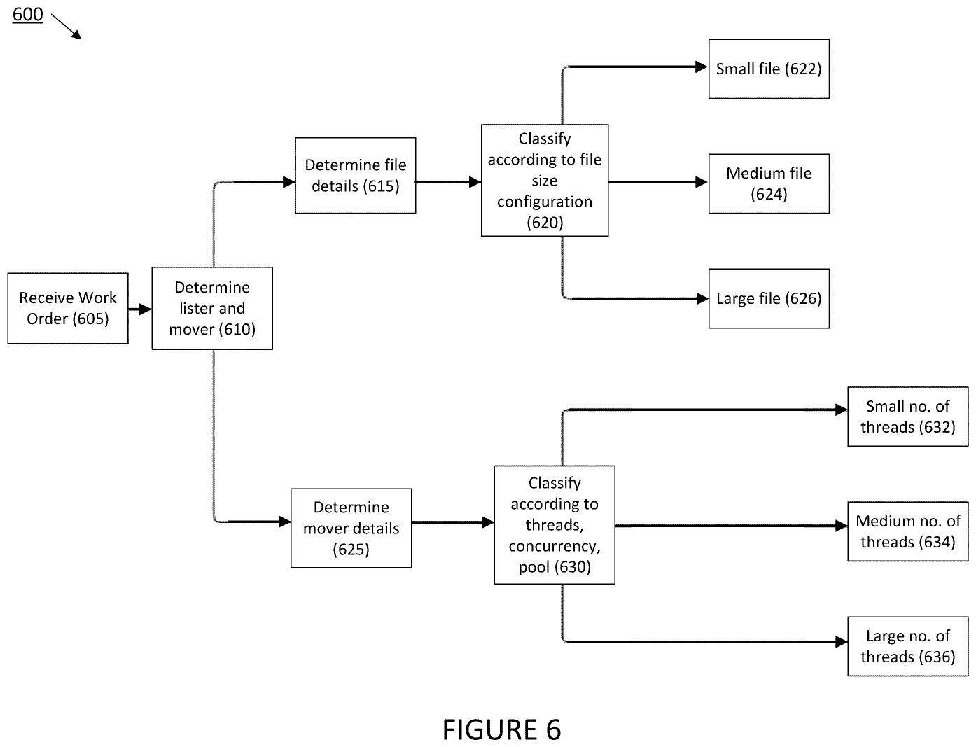

FIG. 6 illustrates a data movement determination process 600 according to some embodiments. Depending on the implementation, the process 600 may be in the form of instructions executed by a processor.

In step 605, a work order can be received at a software module of a data plane. The work order may be in the form of a job call at gateway 120 that is provided to a cluster of computers 125. At a gateway (e.g., gateways 120, 145), the appropriate mover and/or mover configuration can be determined for each data transfer job.

In step 610, a lister and a mover for the data transfer can be determined. In particular, a first connection with a repository of the data to be transferred (e.g., the lister, the agent) can be established, and a second connection with a processor of the file transfer (e.g., the mover, the entitlement agent) can be established. Agent details, roles, capabilities, etc. can be gathered from the connections.

In step 615, file details of the data to be transferred and equipment performing an upload may be determined based on information in the work order and/or the first connection with the lister.

In step 620, the files can be classified based on sizes of files and according to file size configuration. For example, an actual file size can be determined. The file size configuration may be determined based on the actual file size, if a multi-part size is greater or equal to a first threshold, and if a concurrency is greater or equal to a second threshold. The concurrency may be a number of concurrent connections available for data transfer. With reference to the lister, concurrent connections can refer to a number of connections available for upload. For example, the first threshold may be 8 MB and the second threshold may be 10.

In steps 622, 624, and 626, the files can be classified as small, medium, large, or another subset of files based on the multi-part size of files and/or concurrency. For example, small files according to step 622 may be less than 8 MB multi-part size. Medium files according to step 624 may be greater than 8 MB multi-part size but less than 10 concurrent connections. Large files according to step 626 may be greater than 10 concurrent connections. In some embodiments, small, medium, or large (or any subset of files) may be determined as a ratio of concurrent connection to multi-part size.

In step 625, file details of the data to be transferred and equipment performing the data transfer may be determined based on information in the work order and/or the second connection with the mover.

In step 630, the mover can be classified based on threads, concurrency, and a number of data pools. For example, a number of threads available can be determined. The number of concurrent connections available for data transfer can be determined. The number of data pools to be destinations for the data transfer can be determined. The data pool is an online repository capable of storing the data to be transferred. The data pool may be a number of memory available on a number of computers or servers. The classification size may be determined based on number of threads is greater or equal to a thread threshold, a concurrency is greater or equal to a concurrency threshold, a pool is greater than or equal to a pool threshold, and/or a combination of the three factors. For example, a small classification may be associated with one or more of a low concurrency (e.g., 1), a higher number of threads (e.g., 500), and a large pool (e.g., 500). A medium classification may be associated with one or more of a higher concurrency (e.g., 6), a high number of threads (e.g., 500), and a smaller pool (e.g., 80). A large classification may be associated with one or more of a lower number of threads (e.g., 300), a higher concurrency (e.g., 30), and a smaller pool (e.g., 10).

Using the above classifications, lister and movers can be matched to maximize the cluster capacity usage based on the file size and network concurrency. Typically, a larger classification for a mover or a lister can be associated with a longer time for data transfer, where a larger classification for a mover or lister can be associated with a shorter time for data transfer.

In steps 622, 624, and 626, the files can be classified as small, medium, large, or another subset of files based on the multi-part size of files and/or concurrency. For example, small files according to step 622 may be less than 8 MB multi-part size. Medium files according to step 624 may be greater than 8 MB multi-part size but less than 10 concurrent connections. Large files according to step 626 may be greater than 10 concurrent connections. In some embodiments, small, medium, or large (or any subset of files) may be determined as a ratio of concurrent connection to multi-part size.

In some embodiments, files will be categorized for a mover or a lister (e.g., a mover for step 620, a lister for step 630) into small, medium and large (or any subset of files) using a machine learning model to move the data at massive scale based on previous pattern or configuration or computing resource availability. The machine learning model may be trained on previous speeds obtained for previous configurations and defined thresholds, which can be tested and updated for the next data transfer to obtain the optimal configuration for transferring data quickly and efficiently.

In an exemplary aspect, a lister may determine small, medium, and large file sizes based on a specified multipart file size and a specified concurrency parameter. For example, a multipart file size parameter may be specified as 8 MB and any file 8 MB or less in size may be classified as a small file. A medium file may be any file that is greater in size than a specified multi-part file size (e.g., 8 MB) and whose size is less than the product of specified concurrency setting times the specified multipart file size. A large file may be any file whose size is greater than the product of specified concurrency setting times the specified multipart file size.

In some embodiments, step 610 can determine an optimal mover based on the lister including a comparison of classifications and/or capabilities of the mover and the lister. In some embodiments, the mover can be appointed an entitlement agent to fulfill a data movement request for the lister.

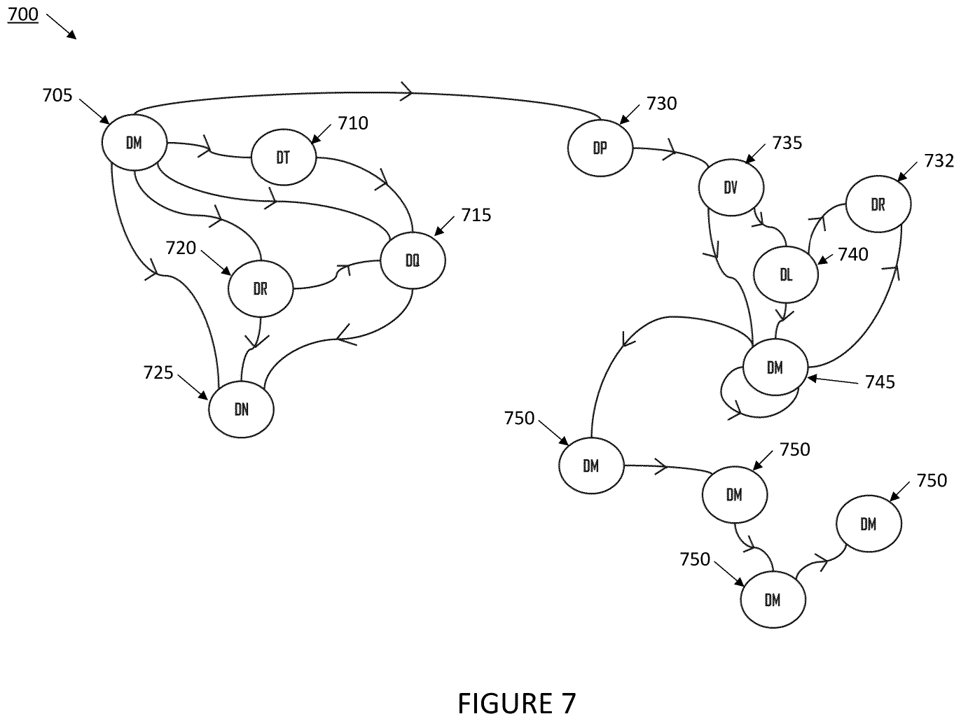

FIG. 7 illustrates a data movement graphical architecture mapping 700 according to some embodiments. Depending on the implementation, the data mapping 700 may be in the form of a mapping display reflecting services, operations, and tasks of a data transfer.

In some embodiments, a control plane may use a graphical architecture in a service-based mapping. For example, based on a type of data processing and/or movement, services may be enabled or disabled based on a specified matrix structure of mapping 700. The mapping 700 may include dependent and independent service tasks. In some embodiments, artificial intelligence such as machine learning (ML) models may be applied in order to determine an optimized execution plan for completion of a data movement work order within the bounds of available resources and time constraints.

Exemplary mapping 700 scales the platform/application horizontally and vertically i.e., (1) if the application wants to complete resources on the platform then increase the operations in nodes (e.g., can increase the child nodes in the graph); or (2) if the application wants to constraint the resources and nodes in a graph are decreased (e.g., based on a specific boundary condition) then based on the specified boundary condition then will be able to control the nodes or child for the operation.

In some embodiments, binary values in a matrix associated with a generated graph may act as conditional (e.g., if-then-else) logic. Such a configuration allows a data movement platform to be agnostic with respect to locations from which data will be moved from and locations to where data will be moved to. In an exemplary aspect, a “1” (or +1) indicates that, after completion of a corresponding task, the service should invoke one or more next services. A “0” represents that there is no parent or child to the service/process (i.e., the current process is a pedant or orphan process and may run independently). A “2” (or +2) may indicate that the process is a cyclic process. Each service represented in the matrix may act as and/or include another graph (i.e., the chain rule). Each service represented in the matrix may act as and/or include another graph (i.e., the chain rule).

In some embodiments, the mapping 700 can be considered as three separate groups including: a task-based mapping including nodes 705, 710, 715, 720, and 725; an operation-based mapping including nodes 730, 735, 740, 745, and 705; and a task-based mapping including nodes 750.

The task-based mapping (e.g., nodes 750) is a lowest unit of work in the graph or work order i.e., where the process/task is executed. Rules and boundary condition will be based on the parent tree i.e., constraint applied at the parent tree or work order. Conditions and/or rules of the task-based mapping nodes may be similar or the same to those used in the parent tree and may be immutable.

In some embodiments, a capability of each data movement node (e.g., data movement nodes 750) can be tracked including a memory, a number of threads, a part size, a concurrency, and an input/output size. The capability of a data movement node and its local connections can be tracked in a matrix such as the below matrix. In this example, a number of threads, part size, concurrency, and input/output size of an adjacent node is supported by the node and, after completion of a corresponding task (e.g., work order), the service should invoke one or more next services.

TABLE 1
Adjacent Matrix (Data Movement)

| | Memory | Thread's | Part Size | Concurrency | IO/Size |
|---|---|---|---|---|---|
| Memory | 0 | +1 | 0 | 0 | 0 |
| Thread's | | 0 | +1 | 0 | 0 |
| Part Size | | | 0 | +1 | 0 |
| Concurrency | | | | 0 | +1 |

The operations-based mapping (e.g., data permission node 730, data validation node 735, data reconciliation node 732, data lister node 740, and data movement node 745) is a sub-process of a parent tree. Rules and boundary condition will be based on the parent tree i.e., constraint applied at the parent tree or work order. For data permission node 730, the model may consider whether the data transfer is permitted, for example based on a UUID, an agent, or a destination (e.g., tenancy). For data reconciliation node 732, the model may consider whether the data in different systems is the same or whether there are discrepancies. For data validation node 735, the model may consider whether the data movement has been validated, for example based on available size constraints. For data lister node 740, the model may consider whether the lister satisfies capabilities consistent with disclosed embodiments. Data movement node 745 may be an iterative process and may be similar to data movement nodes 750 described above. Conditions and/or rules of the operations-based mapping nodes may be similar or the same to those used in the parent tree and may be immutable.

In some embodiments, a capability of the operations-based mapping (e.g., nodes 730, 732, 735, 740, 745) can be tracked including adjacencies between the nodes. The capability may be tracked in a matrix such as the below matrix. An exemplary matrix based on the operations-based mapping of FIG. 7 is shown in Table 2 below.

TABLE 2
Adjacent Matrix (Data Transfer)

| | Data | | | | Data |
|---|---|---|---|---|---|
| | Permis- | Data | Data | Data | Reconcil- |
| | sion | Validation | Lister | Movement | iation |
| | (DP) 730 | (DV) 735 | (DL) 740 | (DM) 745 | (DR) 732 |
| Data | 0 | +1 | 0 | 0 | 0 |
| Permission | | | | | |
| (DP) 730 | | | | | |
| Data | | 0 | +1 | +1 | +1 |
| Validation | | | | | |
| (DV) 735 | | | | | |
| Data Lister | | | 0 | +1 | 0 |
| (DL) 740 | | | | | |
| Data | | | | +2 | +1 |
| Movement | | | | | |
| (DM) 745 | | | | | |
| Data | | | | | 0 |
| Reconcil- | | | | | |
| iation | | | | | |
| (DR) 732 | | | | | |

The service-based mapping (e.g., data movement node 705, data transformation node 710, data quality node 715, data registration node 720, and data notification node 725) represents a number of services, where each service is a parent node. In some embodiments, the services may be reliant on each other. The rules and boundary conditions can be set at each node and applied downstream (e.g., to downstream operations and task-based mappings stemming from each parent node). For data movement node 705, the service may be data transfer. For transformation node 710, the service may be transferring data from one state to another. For data quality node 715, the service may be increasing or ensuring data quality of a dataset. For data registration node 720, the service may be considering whether the dataset is registered in a registration database (e.g., whether a registration identifier of the dataset matches a registration identifier in the database). For data notification node 725, the service may be providing a state of the data or the data transfer consistent with disclosed embodiments.

In some embodiments, capabilities of a service-based mapping (e.g., nodes 705, 710, 715, 720, 725) can be tracked including adjacencies between the nodes. The capability maybe tracked in a matrix such as the below matrix. An exemplary matrix based on the operations-based mapping of FIG. 7 is shown in Table 3 below.

TABLE 3
Adjacent Matrix (Services)

| | | Data | Data | | Data |
|---|---|---|---|---|---|
| | Data | Transfor- | Registra- | Data | Notifica- |
| | Movement | mation | tion | Quality | tion |
| | (DM) 705 | (DT) 710 | (DR) 720 | (DQ) 715 | (DN) 725 |
| Data | 0 | +1 | +1 | +1 | +1 |
| Movement | | | | | |
| (DM) 705 | | | | | |
| Data | | 0 | +1 | +1 | +1 |
| Transfor- | | | | | |
| mation | | | | | |
| (DT) 710 | | | | | |
| Data | | | 0 | 0 | +1 |
| Registration | | | | | |
| (DR) 720 | | | | | |
| Data Quality | | | | 0 | +1 |
| (DQ) 715 | | | | | |
| Data | | | | | 0 |
| Notification | | | | | |
| (DN) 725 | | | | | |

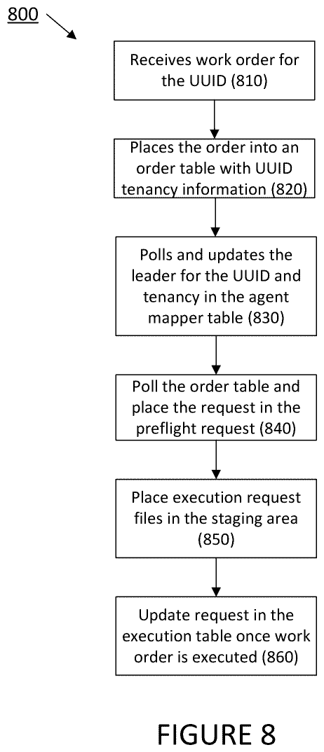

FIG. 8 illustrates a data management and movement process 800 according to some embodiments. Depending on the implementation, the process 800 may be in the form of instructions executed by a processor.

In step 810, a control plane can receive a work order, and upon receipt, it can place the order into an order table with a UUID associated with the work order and associated tenancy information.

In step 820, a scheduler in communication with the order table to determine the current leader appointed to the work order. As discussed above with reference to FIG. 5, the leader can change. The scheduler may ensure the leader is correct for the UUID and tenancy in an agent mapper table.

In step 830, the scheduler will keep polling the order table and place a preflight request to identify an entitlement agent for the preflight request to identify an entitlement agent for the preflight request. The entitlement agent can be identified based on approving the entitlement agent based on a capability identified in a graph-based method (see FIG. 7) and/or a data transfer determination process (see FIG. 6).

In step 840, once the preflight request is complete, then execution request files can be generated and placed in a staging area (see the queue table of FIG. 5) for data movement.

In step 850, once the work order is complete, then an execution table will be updated based on a logical identifier describing the state of the data transfer.

In step 860, if the entitlement agent fails to complete the transfer, then the control plane will allocate a new leader to complete the data transfer. Steps 820 through 850 can repeat until completion of the data transfer.

In some embodiments, a processor in communication with a cloud connected to an agent operating on a user device may be configured to perform the following steps: receiving an indication of a file to be transferred; creating a graphical matrix structure including one or more values for each dependency of a data movement node; for a lister of the indication, determining a lister concurrency and multi-part size of the file; for a mover of the agent, determining a number of threads, a concurrency, and a pool based on the size; determining a mover based on a match of the lister and the mover; and conducting the transfer according to a rule of each dependency of the data movement.

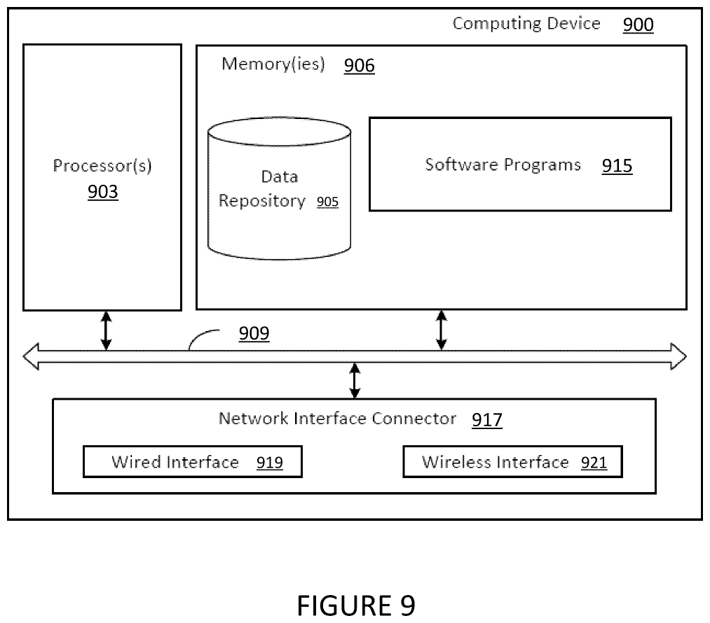

FIG. 9 is a block diagram of a computing device for implementing certain embodiments of the present disclosure. FIG. 9 depicts exemplary computing device 900. Computing device 900 may represent hardware that executes the logic that drives the various system components described herein. For example, system components such as a ML or CLIL model engine, an interface, various database engines and database servers, and other computer applications and logic may include, and/or execute on, components and configurations like, or similar to, computing device 900.

Computing device 900 includes a processor 903 coupled to a memory 906. Memory 906 may include volatile memory and/or persistent memory. The processor 903 executes computer-executable program code stored in memory 906, such as software programs 915. Software programs 915 may include one or more of the logical steps disclosed herein as a programmatic instruction, which can be executed by processor 903. Memory 906 may also include data repository 905, which may be nonvolatile memory for data persistence. The processor 903 and the memory 906 may be coupled by a bus 909. In some examples, the bus 909 may also be coupled to one or more network interface connectors 917, such as wired network interface 919, and/or wireless network interface 921. Computing device 900 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method executed by a processor of one or more computers, the method comprising:
receiving a work order for a data transfer at a control plane from an agent;
generating, by the control plane, an order table including the work order, a tenancy associated with the agent, and a unique identifier associated with the agent;
determining a leader for the work order based on a priority of which leaders are available, a type of port, a type of role associated with the agent, and the unique identifier, wherein the leader is appointed to a logical group of agents and the leader controls an order of the order table;
generating a preflight request to identify an entitlement agent based on a capability of the entitlement agent, the capability comprising a number of available threads; and
based on an approval of the preflight request, generating an execution request for a queue table for execution of the data transfer.

2. The method of claim 1, wherein the unique identifier is generated for the agent based on an internet protocol (IP) address of the agent.

3. The method of claim 1, wherein the capability of the entitlement agent is based on an adjacency identified in a graph-based mapping of services.

4. The method of claim 1, wherein the capability of the entitlement agent is based on matching the capability of the entitlement agent with a data upload capability of the agent.

5. The method of claim 4, wherein the data upload capability of the agent comprising one or more of a multi-part size of a datafile of the data transfer and a concurrency.

6. The method of claim 1, further comprising updating an execution table with a logical identifier indicating a state of the data transfer.

7. The method of claim 6, further comprising, upon the state reflecting that the execution request did not occur, allocating a new leader to complete the data transfer.

8. A system comprising a processor and one or more storage devices storing instructions that when executed by one or more processors, cause the processor to:
receive a work order for a data transfer at a control plane from an agent;
generate, by the control plane, an order table including the work order, a tenancy associated with the agent, and a unique identifier associated with the agent;
determine a leader for the work order based on a priority of which leaders are available, a type of port, a type of role associated with the agent, and the unique identifier, wherein the leader is appointed to a logical group of agents and the leader controls an order of the order table;
generate a preflight request to identify an entitlement agent based on a capability of the entitlement agent, the capability comprising a number of available threads; and
based on an approval of the preflight request, generate an execution request for a queue table for execution of the data transfer.

9. The system of claim 8, wherein the unique identifier is generated for the agent based on an internet protocol (IP) address of the agent.

10. The system of claim 8, wherein the capability of the entitlement agent is based on an adjacency identified in a graph-based mapping of services.

11. The system of claim 8, wherein the capability of the entitlement agent is based on matching the capability of the entitlement agent with a data upload capability of the agent.

12. The system of claim 11, the data upload capability of the agent comprising one or more of a multi-part size of a datafile of the data transfer and a concurrency.

13. The system of claim 8, further comprising updating an execution table with a logical identifier indicating a state of the data transfer.

14. The system of claim 13, further comprising, upon the state reflecting that the execution request did not occur, allocating a new leader to complete the data transfer.

15. A computer processing system comprising:
a memory configured to store instructions; and
a hardware processor operatively coupled to the memory for executing the instructions to:
receive a work order for a data transfer at a control plane from an agent;
generate, by the control plane, an order table including the work order, a tenancy associated with the agent, and a unique identifier associated with the agent;
determine a leader for the work order based on a priority of which leaders are available, a type of port, a type of role associated with the agent, and the unique identifier, wherein the leader is appointed to a logical group of agents and the leader controls an order of the order table;
generate a preflight request to identify an entitlement agent based on a capability of the entitlement agent, the capability comprising a number of available threads; and
based on an approval of the preflight request, generate an execution request for a queue table for execution of the data transfer.

16. The system of claim 15, wherein the unique identifier is generated for the agent based on an internet protocol (IP) address of the agent.

17. The system of claim 15, wherein the capability of the entitlement agent is based on an adjacency identified in a graph-based mapping of services.

18. The system of claim 15, wherein the capability of the entitlement agent is based on matching the capability of the entitlement agent with a data upload capability of the agent.

19. The system of claim 18, wherein the data upload capability of the agent comprising one or more of a multi-part size of a datafile of the data transfer and a concurrency.

20. The system of claim 15, the instructions further comprising updating an execution table with a logical identifier indicating a state of the data transfer.
